(19) United States
(12) Patent Application Publication
(10) Pub. No.: US 2015/0102896 A1
(43) Pub. Date: Apr. 16, 2015

(54) BARRIER LAYER FOR ELECTRICAL FUSES UTILIZING THE METCALF EFFECT

(71) Applicants: GORDON TODD DIETSCH, Park Ridge, IL (US); FRANCISCO URIBE, River Grove, IL (US); FREDERICK DELOS REYES, Lipa City (PH); JOHN J. MONKOWSKI, JR., St. Charles, IL (US)

(72) Inventors: GORDON TODD DIETSCH, Park Ridge, IL (US); FRANCISCO URIBE, River Grove, IL (US); FREDERICK DELOS REYES, Lipa City (PH); JOHN J. MONKOWSKI, JR., St. Charles, IL (US)

(73) Assignee: LITTELFUSE, INC., Chicago, IL (US)

(21) Appl. No.: 14/051,789

(22) Filed: Oct. 11, 2013

(51) Int. Cl. H01H 85/11; H01H 69/02

(52) U.S. Cl. CPC H01H 85/11; H01H 69/02
USPC 337/296; 29/623

(57) ABSTRACT

A fuse including a fuse element, a diffusion layer, and a barrier layer is provided. The barrier layer acts to slow down and/or prevent premature diffusion of the diffusion material into the fuse element during normal operation. As a result, the fuse may be operated in environments having higher ambient temperatures and/or higher currents than otherwise possible. some examples provide a fuse including a fuse element formed from a first conductive material, the fuse element, a barrier layer disposed on a surface of the fuse element, the barrier layer including first and second portions separated by a gap, the barrier layer formed from a second conductive material different from the first conductive material, and a diffusion layer disposed in the gap on the surface of the fuse element, the diffusion layer formed from a third conductive material different from the second conductive material and first conductive material.

### FIELD OF THE DISCLOSURE

This disclosure relates generally to the field of circuit protection devices and more particularly to circuit protection devices that utilize the Metcalf effect.

### BACKGROUND OF THE DISCLOSURE

The Metcalf effect, sometimes referred to as the M-effect, is a technique used to reduce the capacity (e.g., temperature melt-point, current carrying capacity, or the like) of a fuse link. The Metcalf effect operates on principles of diffusion, where during a current overload condition, a low-melt point metal melts and diffuses into a fuse link formed from a high-melt point metal, thereby reducing the current carrying capacity of the fuse link. For example, a low-melt point metal (e.g., tin) may be disposed on a fuse link made of a high-melt point metal (e.g., copper). During a current overload condition, the tin will melt and rapidly diffuse into the copper fuse link, thereby reducing the melting temperature and the current carrying capacity of the copper fuse link below that of pure copper.

The Metcalf effect is often used to create fuse links having opening time versus current characteristics that are not realizable from fuse links formed from a single material. As will be appreciated, the diffusion of the low-melt point metal into the high-melt point metal is dependent upon temperature and the time. Solid state diffusion of the low-melt point metal into the high-melt point fuse link will occur, even at temperatures below the melt point of the low-melt metal. This solid state diffusion is dependent on the types of metal, their grain structure, temperature and time. Accordingly, such fuses must typically be operated in environments having relatively low ambient temperatures, and at relatively low currents, in order to ensure that the solid state diffusion does not adversely affect the operating lifetime of the fuse. Said differently, high ambient operating temperatures may cause the low-melt point metal to prematurely diffuse into the high-melt point metal, thereby changing the intended time and/or current protection characteristics of the fuse. Furthermore, premature diffusion of the low melt-point metal into the high-melt point metal may cause unintended failure of the fuse.

This is particularly problematic in the case of time delay fuses. During a current overload condition, the low melt-point metal first diffuses into the high-melt point metal, causing the fuse to “blow.” Without the low-point metal, the fuse would not blow until the link reached its melting temperature (e.g., 1085° C. for copper). On a short circuit high-current fault this happens very rapidly, but on an overload lower-current fault, the time required to reach the melting temperature might be excessive, resulting in damage to the related circuit or equipment. If the low-melt point metal has already diffused into the high-melt point metal, however, (e.g., due to high ambient operating temperatures, and/or extended operating time), the fuse may blow at lower currents than intended. Thus, there is a need for a fuse that uses the Metcalf effect which is capable of being operated at higher temperatures and/or currents yet still maintain the desired time-current characteristics.

### SUMMARY

In accordance with the present disclosure, fuses utilizing the Metcalf effect are provided. In particular, a barrier layer formed from a third conductive material different than the fuse element or diffusion layer materials is provided. The barrier layer acts to slow down and/or prevent premature diffusion of the diffusion material into the fuse element during normal operation. As a result, the fuse may be operated in environments having higher ambient temperatures and/or higher currents, and/or for longer periods of time than otherwise possible.

In some embodiments, a fuse is provided. The fuse may include a fuse element formed from a first conductive material, a barrier layer disposed on a surface of the fuse element, the barrier layer formed from a second conductive material different from the first conductive material, and a diffusion layer disposed on a surface of the barrier layer, the diffusion layer formed from a third conductive material different from the second conductive material and first conductive material.

In some embodiments, a time delay fuse is provided. The time delay fuse may include a fuse element formed from a first conductive material, the fuse element, a barrier layer disposed on a surface of the fuse element, the barrier layer including first and second portions separated by a gap, the barrier layer formed from a second conductive material different from the first conductive material, and a diffusion layer disposed in the gap on the surface of the fuse element, the diffusion layer formed from a third conductive material different from the second conductive material and first conductive material.

In some embodiments, a method of forming a fuse is provided. The method may include forming a fuse element on a substrate, the fuse element formed from a first conductive material, forming first and second barrier layer portions on a surface of the fuse element, the first and second barrier layer portions separated by a gap and formed from a second conductive material different from the first conductive material, and forming a diffusion layer in the gap on the surface of the fuse element, the diffusion layer formed from a third conductive material different from the second conductive material and first conductive material.

### BRIEF DESCRIPTION OF THE DRAWINGS

By way of example, specific embodiments of the disclosed device will now be described, with reference to the accompanying drawings, in which:

FIGS. 1A-1D are block diagrams of fuses;

FIGS. 2A-2D are block diagrams of fuses;

FIGS. 3A-3D are block diagrams of fuses;

FIG. 4 is a top view of a block diagram of an example fuse;

FIG. 5 is a top view of a block diagram of an example fuse; and

FIG. 6 is a cut-away view of intermetallic layers formed through the Metcalf effect, all arranged in accordance with at least some embodiments of the present disclosure.

### DETAILED DESCRIPTION

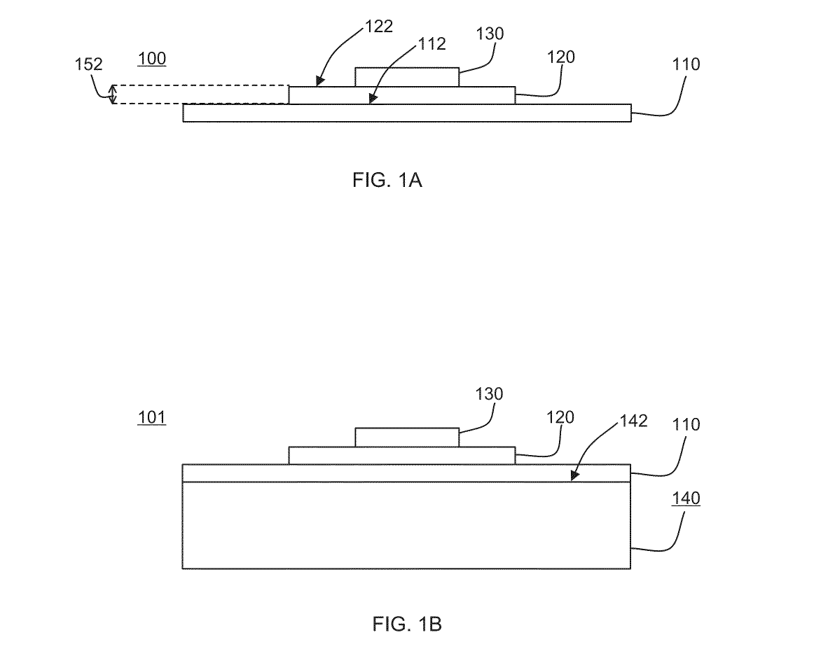

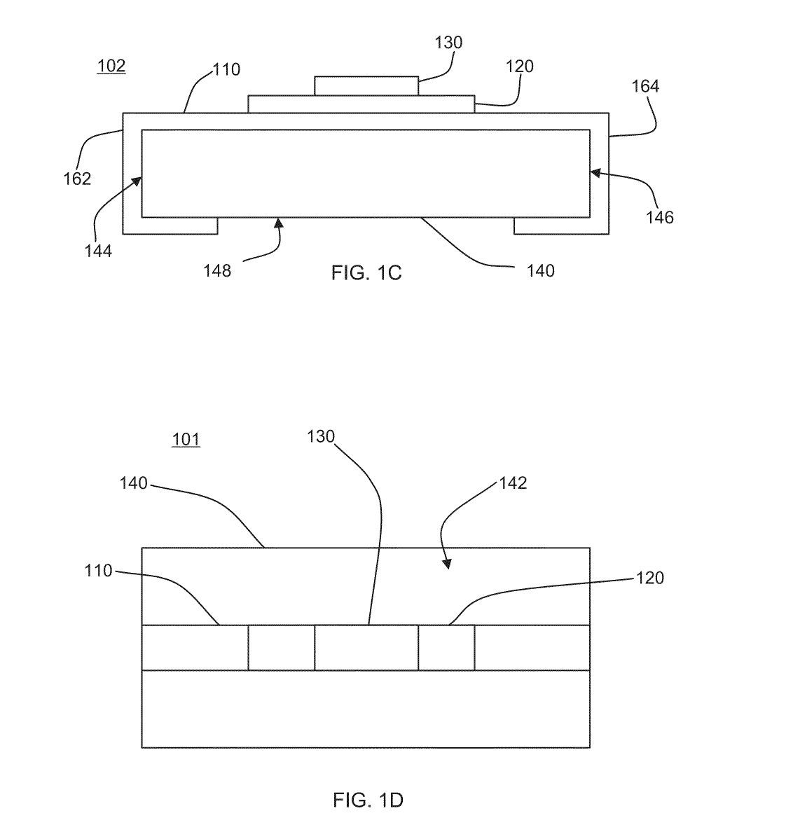

FIG. 1A is a side view illustration of a block diagram of a fuse 100 that operates based on the Metcalf effect. As introduced above, the Metcalf effect occurs where a first conductive material melts and diffuses into a second conductive material, thereby lowering the capacity (e.g., temperature melt-point, current carrying capacity, or the like) of the second conductive material. The fuse 100 may be used to protect a circuit by opening a fusible link (e.g., the fuse element 110 described below) based on the Metcalf effect. More specifically, the fuse element may be used to connect a circuit to be protected to a source of electrical current. During a current overload condition, a diffusion layer (e.g., the diffusion layer 130 described below) will melt and diffuse into the fuse element, thereby lowering the capacity of the fuse element such that the fuse element will open due to the current overload condition exceeding the newly lowered capacity of the fuse element. As a result, an open circuit between the circuit to be protected and the source of electrical current.

A barrier layer (e.g., the barrier layer 120 described below) operates to slow down and or prevent premature diffusion of the diffusion layer into the fuse element, which might result in premature failure and/or premature opening of the fuse. As a result, the fuse 100 may be operated in environments having higher ambient temperatures and/or at higher current levels than otherwise might be possible. More specifically, the fuse 100 may be operated in environments (e.g., high ambient temperature, and/or higher currents, and/or for longer periods of time) without prematurely causing the diffusion layer to melt and diffuse into the fuse element. In some examples, high ambient temperatures may correspond to temperatures above 60 degrees Celsius.

As depicted, the fuse 100 includes a fuse element 110, a barrier layer 120, and a diffusion layer 130. The barrier layer 120 is disposed on a surface of the fuse element 110 (denoted as the surface 112) and the diffusion layer 130 is disposed on a surface of the barrier layer 120 (denoted as the surface 122.) In some embodiments, the diffusion layer 130 may be formed over a portion of the barrier layer 120 (e.g., as depicted in FIG. 1A.) In some embodiments, the diffusion layer 130 may be formed over the entire barrier layer 120 (not shown.) For example, the diffusion layer 130 may be formed to the edges of the barrier layer 120.

The fuse element 110 may be formed from a conductive material having a first melt-point. In some embodiments, the fuse element 110 is formed from a conductive material that includes copper, silver, aluminum, and/or other conductive materials having desirable fuse element characteristics. The diffusion layer 130 may be formed from a conductive material having a second melt-point. In some embodiments, the diffusion layer 130 is formed from a conductive material that includes tin, lead, zinc, and/or other conductive materials having desirable diffusion characteristics. More specifically, the diffusion layer 130 may be formed from a material, which, when diffused into the fuse element 110 creates desirable intermetallic layers that reduce the capacity of the fuse element 110.

It is important to note that in some embodiments, the first melt-point will have a higher temperature value than the second melt-point. Said differently, the conductive material of which the diffusion layer 130 is formed will melt at a lower temperature than the conductive material of which the fuse element 110 is formed will melt.

The barrier layer 120 disposed between the fuse element 110 and the diffusion layer 130 may be formed from a conductive material having a third melt-point. In some embodiments, the barrier layer 120 may be formed from a conductive material that includes nickel, and/or other conductive materials having desirable diffusion barrier or diffusion slowing characteristics. In some embodiments, the third melt-point may have a higher temperature value than the first melt-point and the second melt-point. Said differently, the conductive material of which the barrier layer 120 is formed will melt at a higher temperature than the conductive material of which the diffusion layer is formed, and at a higher temperature than the conductive material of which the fuse element is formed will. Accordingly, when the fuse 100 is operated in environments with elevated ambient temperatures and or operating currents, the diffusion layer 130 may not prematurely (e.g., prior to a current overload conditions, or the like) diffuse into the fuse element 110.

In some embodiments, the thickness (denoted by thickness 152) of the barrier layer 120 may be selected such that desired resistance and/or current protection is achieved. Said differently, the thickness 152 of the barrier layer 120 may be selected to achieve a desired resistance of the fuse element 110 during normal operating conditions. Additionally, the thickness 152 may be selected such that diffusion of the diffusion layer 130 into the fuse element 110 is slowed for a desired amount of time during normal operation of the fuse in environments with high ambient temperatures. Furthermore, the thickness 152 may be selected such that the fuse element has a desired current-carrying capacity or ampere rating (e.g., 0.125 Amps, 0.25 Amps, 0.5 Amps, 1 Amp, 5 Amps, 10 Amps, 20 Amps, or the like.) In some examples, the thickness 152 may be between 5 and 500 micro inches.

FIG. 1B is a side view illustration of a fuse 101 according to some embodiments of the present disclosure. The fuse 101 includes the fuse element 110, the barrier layer 120, and the diffusion layer 130 described above, as well as a substrate 140. As depicted, the fuse 101 includes the fuse element 110 mounted or formed on a surface of substrate 140 (denoted as the surface 142.) The barrier layer 120 is disposed on a surface of the fuse element 110 and the diffusion layer 130 is disposed on a surface of the barrier layer 120. In some embodiments, the substrate 140 may be any type of suitable non-conductive substrate material, such as, FR4 material. The substrate 140 may be used to give support to the fuse element 110 during manufacturing, shipping, installation, and/or use.

FIG. 1C is a side view illustration of a fuse 102 according to some embodiments of the present disclosure. The fuse 102 includes the fuse element 110, the barrier layer 120, the diffusion layer 130, and the substrate 140. The fuse 102 further includes fuse terminals 162 and 164, which are disposed on side surfaces of the substrate 140 (denoted as surfaces 144 and 146 respectively) and on a bottom surface of the substrate 140 (denoted as surface 148.) In some embodiments, the fuse element 110 may be extended onto the side surfaces and bottom surface of the substrate 140 in order to form the fuse terminals 162 and 164. In some embodiments, fuse terminals 162 and 164 may be formed (e.g., by plating, or the like) of conductive material onto the side and bottom surfaces of the substrate 140 such that the fuse terminals 162 and 164 are in electrical communication with the fuse element 110. The configuration depicted in FIG. 1C may be suited to surface mount applications or the like.

FIG. 1D is a top view illustration of a block diagram of the fuse 101 depicted in FIG. 1B. As depicted, the fuse element 110 is disposed on a portion of the surface 142 of the substrate 140. Furthermore, the barrier layer 120 is depicted disposed on the fuse element 110 and the diffusion layer 130 is depicted disposed on the barrier layer 120. Forming the layers on the substrate 140 is beyond the scope of this disclosure. However, various techniques for forming the fuse element 110, the barrier layer 120, and the diffusion layer 130 on the substrate 140 are known. It is to be appreciated, that any of a variety of these techniques (e.g., photolithography, etching, plating, or the like) may be used to form the fuse arrangements described herein.

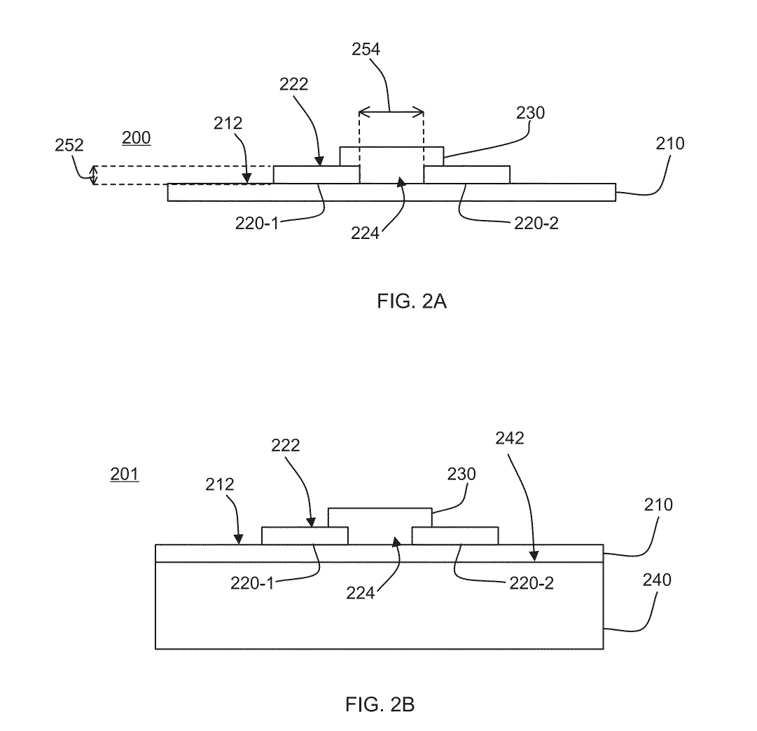

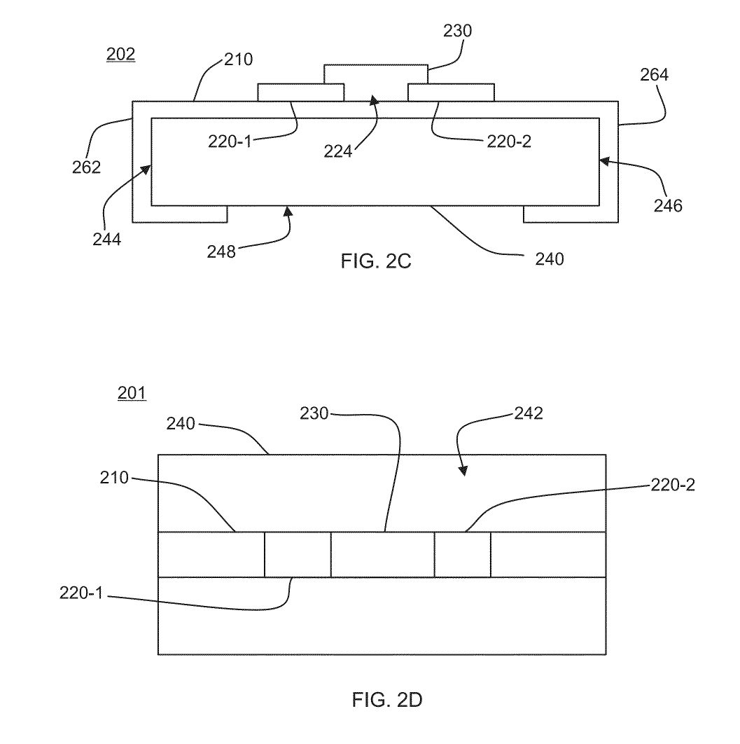

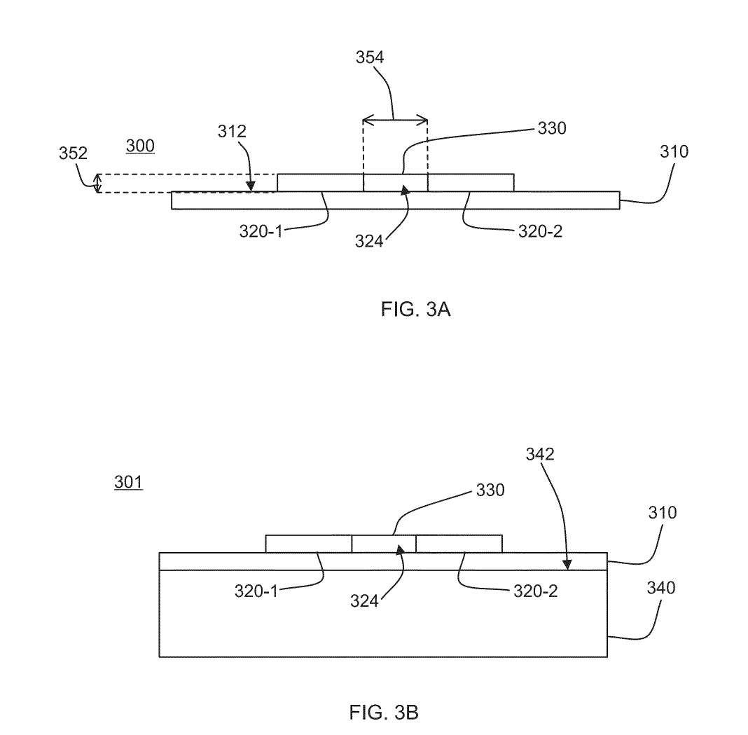

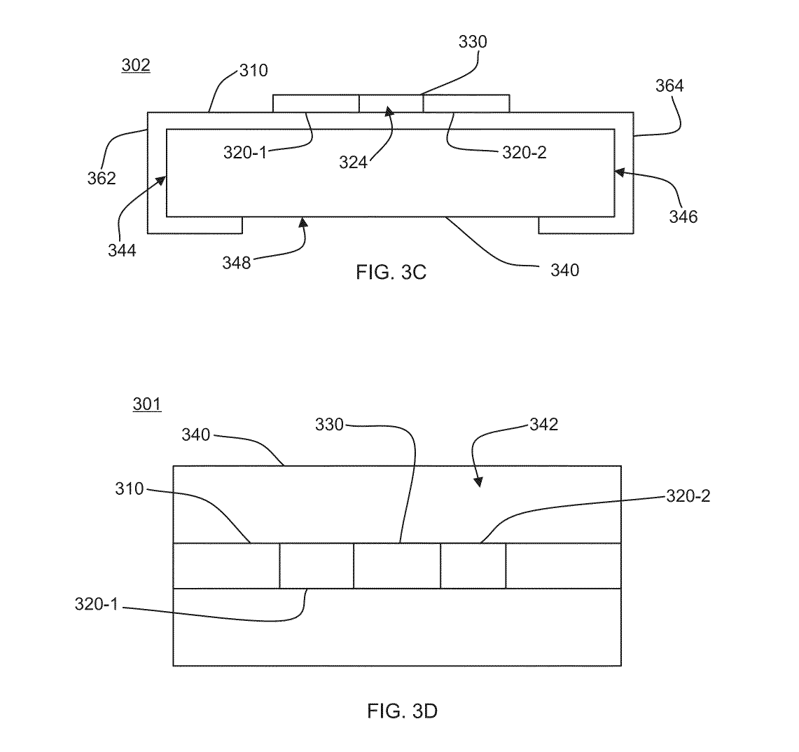

FIGS. 2A-2D and FIGS. 3A-3D illustrate embodiments of the present disclosure. These embodiments describe fuses that operate on the Metcalf effect. The illustrated fuses are similar in operation to the fuses described above with respect to FIGS. 1A-1D, and similar number conventions have been followed for these figures for ease of reference between similar components.

Turning now to FIG. 2A, a side view illustration of a block diagram of a fuse 200 is shown. As depicted, the fuse 200 includes a fuse element 210 and a barrier layer 220 formed on a surface of the fuse element 210 (denoted by the surface 212.) As depicted, the barrier layer 220 includes a first portion 220-1 and a second portion 220-2 with a gap 224 having a width 254 there between. A diffusion layer 230 is disposed in the gap 224 and partially over the barrier layer portions 220-1 and 220-2. More specifically, the diffusion layer 230 is disposed on the surface 212 of the fuse element 210 as well as on portions of a surface of the barrier layer portions 220-1 and 220-2 (denoted by the surface 222.)

The fuse element 210 may be formed from a conductive material having a first melt-point. In some embodiments, the fuse element 210 is formed from a conductive material that includes copper, silver, aluminum, and/or other conductive materials having desirable fuse element characteristics. The diffusion layer 230 may be formed from a conductive material having a second melt-point. In some embodiments, the diffusion layer 230 is formed from a conductive material that includes tin, lead, zinc, and/or other conductive materials having desirable diffusion characteristics. More specifically, the diffusion layer 230 may be formed for a material, which, when diffused into the fuse element 210 creates desirable intermetallic layers that reduce the capacity of the fuse element 210.

It is important to note, that in some embodiments, the first melt-point will have a higher temperature value than the second melt-point. Said differently, the conductive material of which the diffusion layer 230 is formed will melt at a lower temperature than the conductive material of which the fuse element 210 is formed will melt.

The barrier layer 220 disposed between the fuse element 210 and the diffusion layer 230 may be formed from a conductive material having a third melt-point. In some embodiments, the barrier layer 220 may be formed from a conductive material that includes nickel, and/or other conductive materials having desirable diffusion barrier or diffusion slowing characteristics. In some embodiments, the third melt-point may have a higher temperature value than the first melt-point and the second melt-point. Said differently, the conductive material of which the barrier layer 220 is formed will melt at a higher temperature than the conductive material of which the diffusion layer is formed, and at a higher temperature than the conductive material of which the fuse element is formed will melt. Accordingly, when the fuse 200 is operated in environments with elevated ambient temperatures or at higher operating currents, the diffusion layer 230 may not prematurely (e.g., prior to a current overload conditions, or the like) diffuse into the fuse element 210.

In some embodiments, the thickness (denoted by thickness 252) of the barrier layer 220 may be selected such that desired resistance and/or current protection is achieved. Said differently, the thickness 252 of the barrier layer 220 may be selected to achieve a desired resistance of the fuse element 210 during normal operating conditions. Additionally, the thickness 252 may be selected such that diffusion of the diffusion layer 230 into the fuse element 210 is slowed for a desired amount of time during normal operation of the fuse in environments with high ambient temperatures and/or high operating currents. Furthermore, the thickness 252 may be selected such that the fuse element has a desired current-carrying capacity or ampere rating (e.g., 0.125 Amps, 0.25 Amps, 0.5 Amps, 1 Amp, 5 Amps, 10 Amps, 20 Amps, or the like.) In some examples, the thickness 252 may be between 5 and 500 micro inches.

During a current overload condition, the diffusion layer 230 may melt and diffuse into the fuse element 210 thereby changing the intermetallic characteristics of the fuse element 210 and causing the fuse element 210 to open due to the current overload condition. In non-current overload conditions, the barrier layer portions 220-1 and 220-2 may prevent premature diffusion of the diffusion layer 230 into the fuse element 210, even when operated in environments with elevated ambient temperatures. The width of the gap 224 (denoted by the width 254) may be selected such that the diffusion of the diffusion layer 230 into the fuse element 210 is appropriately slowed. Said differently, the width 254 may be selected such that the fuse 200 may be operated in environments having desired ambient temperature ranges and/or high operating currents without the diffusion layer 230 prematurely diffusing into the fuse element 210. In some examples, the width 254 may be between 1.5 mils and 20 mils.

FIG. 2B is a side view illustration of a fuse 201 according to some embodiments of the present disclosure. The fuse 201 includes the fuse element 210, the barrier layer portions 220-1 and 220-2, and the diffusion layer 230 described above, as well as a substrate 240. As depicted, the fuse 201 includes the fuse element 210 mounted or formed on a surface of the substrate 240 (denoted as the surface 242.) The barrier layer portions 220-1 and 220-2 are disposed on the surface 212 of the fuse element 210 and the diffusion layer 230 is disposed in the gap 224 on the surface 212 of the fuse element 210, as well as on portions of the barrier layer portions 220-1 and 220-2. In some embodiments, the substrate 240 may be any type of suitable non-conductive substrate material, such as, FR4 material. The substrate 240 may be used to give support to the fuse element 210 during manufacturing, shipping, installation, and/or use.

FIG. 2C is a side view illustration of a fuse 202 according to some embodiments of the present disclosure. The fuse 202 includes the fuse element 210, the barrier layer 220, the diffusion layer 230, and the substrate 240. The fuse 202 further includes fuse terminals 262 and 264, which are disposed on side surfaces of the substrate 240 (denoted as surfaces 244 and 246 respectively) and on a bottom surface of the substrate 240 (denoted as surface 248.) In some embodiments, the fuse element 210 may be extended onto the side surfaces and bottom surface of the substrate 240 in order to form the fuse terminals 262 and 264. In some embodiments, fuse terminals 262 and 264 may be formed (e.g., by plating, or the like) from conductive materials onto the side and bottom surfaces of the substrate 240 such that the fuse terminals 262 and 264 are in electrical communication with the fuse element 210. The configuration depicted in FIG. 2C may be suited to surface mount applications or the like.

FIG. 2D is a top view illustration of a block diagram of the fuse 201 depicted in FIG. 2B. As depicted, the fuse element 210 is disposed on a portion of the surface 242 of the substrate 240. Furthermore, the barrier layer portions 220-1 and 220-2 are depicted disposed on the fuse element 210 and the diffusion layer 230 is depicted disposed in the gap between the barrier layer portions 220-1 and 220-2 as well as partially on the barrier layer portions.

Turning now to FIG. 3A, a side view illustration of a block diagram of a fuse 300 is shown. As depicted, the fuse 300 includes a fuse element 310 and a barrier layer 320 formed on a surface of the fuse element 310 (denoted by the surface 312.) As depicted, the barrier layer 320 includes a first portion 320-1 and a second portion 320-2 with a gap 324 having a width 354 there between. A diffusion layer 330 is disposed in the gap 324. More specifically, the diffusion layer 330 is disposed within the gap 324 on the surface 312 of the fuse element 310.

The fuse element 310 may be formed from a conductive material having a first melt-point. In some embodiments, the fuse element 310 is formed from a conductive material that includes copper, silver, aluminum, and/or other conductive materials having desirable fuse element characteristics. The diffusion layer 330 may be formed from a conductive material having a second melt-point. In some embodiments, the diffusion layer 330 is formed from a conductive material that includes tin, lead, zinc, and/or other conductive materials having desirable diffusion characteristics. More specifically, the diffusion layer 330 may be formed from a material, which, when diffused into the fuse element 310 creates desirable intermetallic layers that reduce the capacity of the fuse element 310.

It is important to note that in some embodiments, the first melt-point will have a higher temperature value than the second melt-point. Said differently, the conductive material of which the diffusion layer 330 is formed will melt at a lower temperature than the conductive material of which the fuse element 310 is formed will melt.

The barrier layer 320 disposed between the fuse element 310 and the diffusion layer 330 may be formed from a conductive material having a third melt-point. In some embodiments, the barrier layer 320 may be formed from a conductive material that includes nickel, and/or other conductive materials having desirable diffusion barrier or diffusion slowing characteristics. In some embodiments, the third melt-point may have a higher temperature value than the first melt-point and a higher temperature value than the second melt-point. Said differently, the conductive material of which the barrier layer 320 is formed will melt at a higher temperature than the conductive material of which the diffusion layer is formed, and at a higher temperature than the conductive material of which the fuse element is formed will. Accordingly, when the fuse 300 is operated in environments with elevated ambient temperatures and/or higher operating current levels, the diffusion layer 330 may not prematurely (e.g., prior to a current overload conditions, or the like) diffuse into the fuse element 310.

In some embodiments, the thickness (denoted by thickness 352) of the barrier layer 320 may be selected such that desired resistance and/or current protection is achieved. Said differently, the thickness 352 of the barrier layer 320 may be selected to achieve a desired resistance of the fuse element 310 during normal operating conditions. Additionally, the thickness 352 may be selected such that diffusion of the diffusion layer 330 into the fuse element 310 is slowed for a desired amount of time during normal operation of the fuse in environments with high ambient temperatures and/or high operating currents. Furthermore, the thickness 352 may be selected such that the fuse element has a desired current-carrying capacity or ampere rating (e.g., 0.125 Amps, 0.25 Amps, 0.5 Amps, 1 Amp, 5, Amps, 10 Amps, 20 Amps, or the like.) In some examples, the thickness 352 may be between 5 and 500 micro inches.

During a current overload condition, the diffusion layer 330 may melt and diffuse into the fuse element 310 thereby changing the intermetallic characteristics of the fuse element 310 and causing the fuse element 310 to open due to the current overload condition. In non-current overload conditions, the barrier layer portions 320-1 and 320-2 may prevent premature diffusion of the diffusion layer 330 into the fuse element 310, even when operated in environments with elevated ambient temperatures and/or high operating current levels. The width of the gap 324 (denoted by the width 354) may be selected such that the diffusion of the diffusion layer 330 into the fuse element 310 is appropriately slowed. Said differently, the width 354 may be selected such that the fuse 300 may be operated in environments having desired ambient temperature ranges without the diffusion layer 330 prematurely diffusing into the fuse element 310. In some examples, the width 354 may be between 1.5 mils and 20 mils.

FIG. 3B is a side view illustration of a fuse 301 according to some embodiments of the present disclosure. The fuse 301 includes the fuse element 310, the barrier layer portions 320-1 and 320-2, and the diffusion layer 330 described above, as well as a substrate 340. As depicted, the fuse 301 includes the fuse element 310 mounted or formed on a surface of the substrate 340 (denoted as the surface 342.) The barrier layer portions 320-1 and 320-2 are disposed on the surface 312 of the fuse element 310 and the diffusion layer 330 is disposed in the gap 324 on the surface 312 of the fuse element 310. In some embodiments, the substrate 340 may be any type of suitable non-conductive substrate material, such as, FR4 material. The substrate 340 may be used to give support to the fuse element 310 during manufacturing, shipping, installation, and/or use.

FIG. 3C is a side view illustration of a fuse 302 according to some embodiments of the present disclosure. The fuse 302 includes the fuse element 310, the barrier layer 320, the diffusion layer 330, and the substrate 340. The fuse 302 further includes fuse terminals 362 and 364, which are disposed on side surfaces of the substrate 340 (denoted as surfaces 344 and 346 respectively) and on a bottom surface of the substrate 340 (denoted as surface 348.) In some embodiments, the fuse element 310 may be extended onto the side surfaces and bottom surface of the substrate 340 in order to form the fuse terminals 362 and 364. In some embodiments, fuse terminals 362 and 364 may be formed (e.g., by plating, or the like) conductive material onto the side and bottom surfaces of the substrate 340 such that the fuse terminals 362 and 364 are in electrical communication with the fuse element 310. The configuration depicted in FIG. 3C may be suited to surface mount applications or the like.

FIG. 3D is a top view illustration of a block diagram of the fuse 301 depicted in FIG. 3B. As depicted, the fuse element 310 is disposed on a portion of the surface 342 of the substrate 340. Furthermore, the barrier layer portions 320-1 and 320-2 are depicted disposed on the fuse element 310 and the diffusion layer 330 is depicted disposed in the gap between the barrier layer portions 320-1 and 320-2.

The fuses 300, 301, and 302 depicted in FIGS. 3A-3D may provide for reduced passivation of the barrier layer portions 320-1 and 320-1 during embodiments where the diffusion layer 330 is formed using plating techniques. More specifically, as the diffusion layer 330 is deposited in the gap 324, the barrier layer portions may be entirely covered (e.g., masked off) such that the barrier layer portions may not be exposed during the plating process and passivation may be reduced.

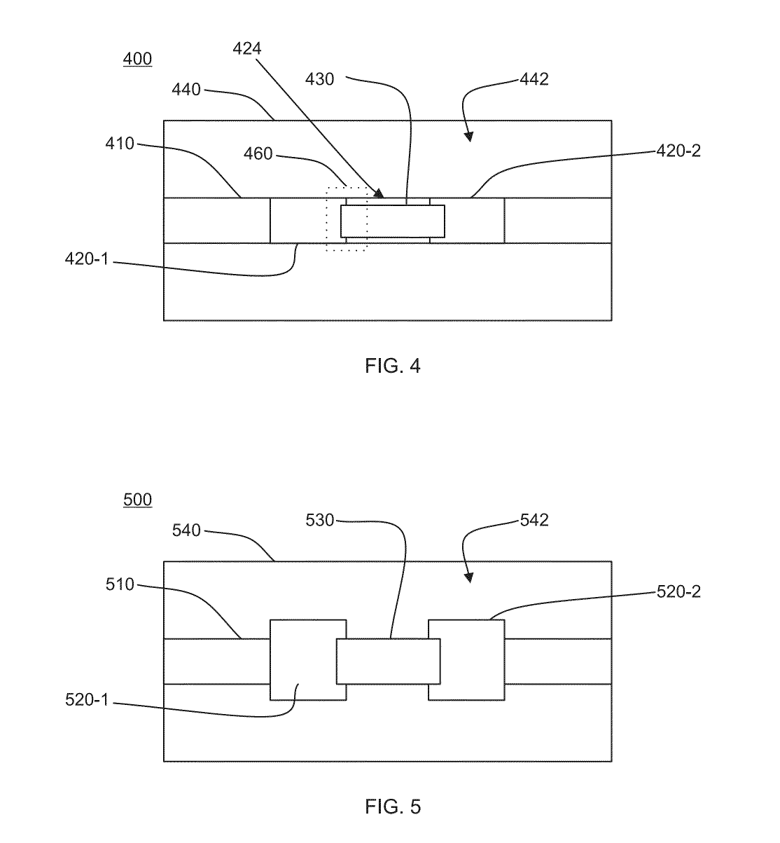

FIG. 4 is a top view illustration of a block diagram of a fuse 400. As can be seen, the fuse 400 has a fuse element 410 disposed on a surface 442 of a substrate 440. Barrier layer portions 420-1 and 420-2 are disposed on the fuse element 410 and a diffusion layer 430 is in a gap 424 between the barrier layer portions. The diffusion layer 430, however, is offset from the gap 424 as can be seen in region 460. This is illustrated to show, for example, how various processing techniques may result in a slight offset of the deposition of the diffusion layer 430 with respect to the gap 424 in the barrier layer portions. Due to the overlapping of the diffusion layer 430 with the barrier layer portions 420-1 and 420-2, however, the slight misalignment may not be an issue with performance and functioning of the fuse 400.

FIG. 5 is a top view illustration of a block diagram of a fuse 500. As can be seen, the fuse 500 has a fuse element 510 disposed on a surface 542 of a substrate 550. Barrier layer portions 520-1 and 520-2 are disposed on the fuse element 510. The barrier layer portions 520-1 and 520-2, however, are larger in one dimension than the fuse element 510. As such, the barrier layer portions are disposed on portions of the fuse element 510 as well as the surface 542 of the substrate 540. In some examples, the larger barrier layer portions may facilitate heat dissipation in the fuse 500, thus allowing for the fuse 500 to be operated in environment with higher ambient temperatures and/or higher operating current levels.

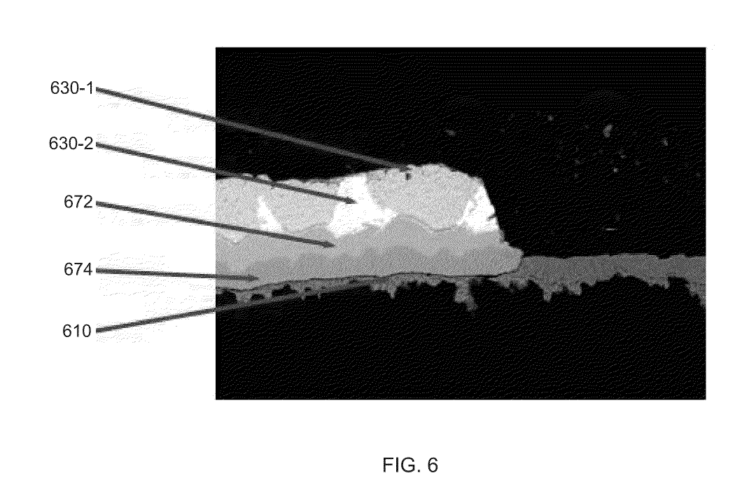

FIG. 6 illustrates a cut-away view of intermetallic layers formed through the Metcalf effect. More specifically, a fuse element layer 610 comprising a first conductive material is shown. Additionally, a diffusion layer 630 comprising a second conductive material is shown. As depicted, the diffusion layer 630 is an alloy with two principal materials depicted as 630-1 and 630-2. It is to be appreciated, however, that other materials, even a single conductive material may be used for the diffusion layer and the intermetallic formations described herein may be similar. Intermetallic layers 672 and 674 are shown. The intermetallic layers 672 and 674 cause the resistance of the fuse element layer 610 to increase, which increases Joule self-heating of the fuse element. Furthermore, intermetallic layers 672 and 674 have a melt point significantly lower than that the fuse element 610. The combination of increased Joule heating and reduced melt point, cause the fuse element 610 and the overlying materials to “blow” or open.

1. A fuse comprising:
a fuse element formed from a first conductive material;
a barrier layer disposed on a surface of the fuse element, the barrier layer formed from a second conductive material different from the first conductive material; and
a diffusion layer disposed on a surface of the barrier layer, the diffusion layer formed from a third conductive material different from the second conductive material and first conductive material.

2. The fuse of claim 1, wherein the barrier layer includes a first barrier layer portion and a second barrier layer portion separated by a gap and wherein the diffusion layer is further disposed in the gap and on the surface of the fuse element between the first and second barrier layer portions.

3. The fuse of claim 2, wherein the gap has a width of between 1.5 mils and 20 mils.

4. The fuse of claim 1, where the barrier layer has a thickness between 5 and 500 micro inches.

5. The fuse of claim 1, wherein the second conductive material includes nickel.

6. The fuse of claim 1, wherein the second conductive material has a higher melt-point than the first conductive material.

7. The fuse of claim 6, wherein the third conductive material has a lower melt-point than the second conductive material.

8. The fuse of claim 1, further comprising a substrate, wherein the fuse element is disposed on the substrate.

9. The fuse of claim 8, further comprising a first terminal and a second terminal, the first and second terminal configured to connect the fuse to a circuit to be protected and a source of power.

10. A fuse comprising:
a fuse element formed from a first conductive material, the fuse element;
a barrier layer disposed on a surface of the fuse element, the barrier layer including first and second portions separated by a gap, the barrier layer formed from a second conductive material different from the first conductive material; and
a diffusion layer disposed in the gap on the surface of the fuse element, the diffusion layer formed from a third conductive material different from the second conductive material and first conductive material.

11. The fuse of claim 10, wherein the barrier layer slows down diffusion of the diffusion layer into the fuse element during operation of the fuse in environments having high ambient temperatures except in the event of a current overload condition.

12. The fuse of claim 10, wherein the gap has a width of between 1.5 mils and 20 mils.

13. The fuse of claim 10, where the barrier layer has a thickness between 5 and 500 micro inches.

14. The fuse of claim 10, wherein the second conductive material includes nickel.

15. The fuse of claim 10, wherein the second conductive material has a higher melt-point than the first conductive material.

16. The fuse of claim 15, wherein the third conductive material has a lower melt-point than the second conductive material.

17. The fuse of claim 10, further comprising a substrate, wherein the fuse element is disposed on the substrate.

18. The fuse of claim 17, further comprising a first terminal and a second terminal, the first and second terminal configured to connect the fuse to a circuit to be protected and a source of power.

19. A method of forming a fuse comprising:
forming a fuse element on a substrate, the fuse element formed from a first conductive material;
forming first and second barrier layer portions on a surface of the fuse element, the first and second barrier layer portions separated by a gap and formed from a second conductive material different from the first conductive material; and
forming a diffusion layer in the gap on the surface of the fuse element, the diffusion layer formed from a third conductive material different from the second conductive material and first conductive material.

20. The method of claim 19, wherein the gap is between 1.5 mils and 20 mils.

21. The method of claim 19, wherein the first and second barrier layer portions have has a thickness between 5 and 500 micro inches.

22. The method of claim 19, wherein the second conductive material includes nickel.
